(19) United States
(12) Patent Application Publication
(10) Pub. No.: US 2026/0105052 A1
(43) Pub. Date: Apr. 16, 2026

(54) DATA QUERY METHOD AND RELATED DEVICE

(71) Applicant: Alipay (Hangzhou)Digital Service Technology Co., Ltd., Hangzhou (CN)

(72) Inventor: Xiangchun WANG, Hangzhou (CN)

(21) Appl. No.: 19/420,522

(22) Filed: Dec. 15, 2025

Related U.S. Application Data
(63) Continuation-in-part of application No. PCT/CN2024/107458, filed on Jul. 25, 2024.

(30) Foreign Application Priority Data
Aug. 1, 2023 (CN) 202310958300

(51) Int. Cl. G06F 16/2455; G06F 16/22

(52) U.S. Cl. CPC G06F 16/24554; G06F 16/2255

(57) ABSTRACT

The present specification provides a data query method and a related device. The method includes: parsing a historical query statement for a target data table, to obtain at least one data dimension included in a query condition in the historical query statement; determining a target data dimension from the at least one data dimension, and performing partitioning processing on the target data table based on the target data dimension, to divide the target data table into a plurality of data partitions; and obtaining a to-be-executed target query statement, and executing the target query statement, to perform query processing in each of the plurality of data partitions.

### TECHNICAL FIELD

One or more implementations of the present specification relate to the field of data query technologies, and in particular, to a data query method and a related device.

### BACKGROUND

When a large-scale data table including a large amount of data is queried, to improve query performance, the data table usually is partitioned based on a specific data dimension (for example, user, region, or time), to distribute and store the large amount of data in a plurality of partitions. As such, fast and efficient query processing can be performed in each partition.

### SUMMARY

Inventors recognize that different users have different data query requirements or the same user has different data query requirements in different use scenarios. If a data dimension about which a user subsequently performs a query is different from a previous partition dimension of the data table (for example, the user wants to query data about a user Jim, but the data table is already partitioned based on a region), the data table will be re-partitioned based on the new data dimension. Consequently, a large amount of data will be moved, which affects query performance. For example, a long period of running time will be used for the re-partition, which will also cause pressure on a disk.

One or more implementations of the present specification provide a data query method and a related device.

According to a first aspect, the present specification provides a data query method, including: parsing a historical query statement for a target data table, to obtain at least one data dimension included in a query condition in the historical query statement; determining a target data dimension from the at least one data dimension, and performing partitioning processing on the target data table based on the target data dimension, to divide the target data table into a plurality of data partitions; and obtaining a to-be-executed target query statement, and executing the target query statement, to perform query processing in each of the plurality of data partitions.

According to a second aspect, the present specification provides a data query apparatus, including: a parsing unit, configured to parse a historical query statement for a target data table, to obtain at least one data dimension included in a query condition in the historical query statement; a partitioning processing unit, configured to: determine a target data dimension from the at least one data dimension, and perform partitioning processing on the target data table based on the target data dimension, to divide the target data table into a plurality of data partitions; and a data query unit, configured to: obtain a to-be-executed target query statement, and execute the target query statement, to perform query processing in each of the plurality of data partitions.

Correspondingly, the present specification further provides a computer device, including a storage and a processor. The storage stores a computer program that is capable of being run by the processor, and when running the computer program, the processor performs the data query method according to the first aspect.

Correspondingly, the present specification further provides a computer-readable storage medium. The computer-readable storage medium stores a computer program, and when the computer program is run by a processor, the data query method according to the first aspect is performed.

In conclusion, in the present application, the historical query statement for the target data table can be obtained, and the historical query statement is parsed, to obtain the at least one data dimension included in the historical query statement; and then the target data dimension is determined from the at least one data dimension. Further, in the present application, partitioning processing can be performed on the target data table based on the target data dimension, to divide the target data table into the plurality of data partitions, and some data in the target data table is stored in each data partition. Subsequently, after the to-be-executed target query statement is received in the present application, because the target data table is partitioned in advance based on a historical query requirement of a user in the present application, query processing can be directly performed in each of the plurality of data partitions obtained through division, and the data table does not need to be re-partitioned, thereby greatly improving data query performance.

### BRIEF DESCRIPTION OF DRAWINGS

FIG. 1 is a schematic diagram of a system architecture according to an example implementation;

FIG. 2 is a schematic flowchart of a data query method according to an example implementation;

FIG. 3 is a schematic structural diagram of a data query apparatus according to an example implementation; and

FIG. 4 is a schematic structural diagram of a computer device according to an example implementation.

### DESCRIPTION OF EMBODIMENTS

Example implementations are described in detail herein, and examples of the example implementations are presented in the accompanying drawings. When the following description relates to the accompanying drawings, unless specified otherwise, same numbers in different accompanying drawings represent same or similar elements. The implementations described in the following example implementations do not represent all implementations consistent with one or more implementations of the present specification. On the contrary, the implementations are merely examples of apparatuses and methods consistent with some aspects of one or more implementations of the present specification and the appended claims.

It should be noted that, in various implementations, the steps of the methods described herein are not necessarily performed in the sequence shown and described in the present specification. In some implementations, the method can include more or fewer steps than those described in the present specification. In addition, a single step described in the present specification may be broken down into a plurality of steps in other implementations for description, and a plurality of steps described in the present specification may be combined into a single step in other implementations for description.

It should be noted that the “a plurality of” in the present application means two or more.

In addition, user information (including but not limited to a device information of a user, personal information of a user, etc.) and data (including but not limited to data used for analysis, stored data, displayed data, etc.) used in the present application are information and data that are authorized by the user or fully authorized by each party, related data to be collected, used, and processed by abiding by related laws and regulations and standards of a related country and region, and a corresponding operation entry is provided, so that the user chooses to perform authorization or rejection.

First, some terms in the present specification are explained for understanding by a person skilled in the art.

(1) Partitioning is to divide one data table into a plurality of data partitions. Each data partition can store some data in the data table, but logically, the data table is still the original complete data table. In other words, through partitioning, no new data table is generated, but merely, data in the data table is allocated to different storage spaces. As such, for a large-scale data table including massive data, the massive data may not be centrally stored in one place through partitioning. Subsequently, when the data table is queried, query processing can be performed in each of a plurality of data partitions, thereby improving data query efficiency.

Further, during data partitioning, data division is usually performed on the data table based on a data dimension in the data table, and the data dimension is a partition key. It can be understood that different data dimensions usually correspond to different data columns (e.g., different keys) in the data table.

For example, the data dimension can be a city. In this case, after the data table is partitioned based on a city dimension, only data related to a city A can be stored in one data partition, only data related to a city B can be stored in another data partition, etc. For example, the data dimension can alternatively be a user. In this case, after the data table is partitioned based on a user dimension, only data related to a user A can be stored in one data partition, only data related to a user B can be stored in another data partition, etc. Examples are omitted herein for simplicity.

As described above, different users have different data query requirements or the same user has different data query requirements in different use scenarios. If a data dimension about which a user subsequently performs a query is different from a partition dimension of the data table, the data table will be re-partitioned based on a new dimension.

For example, in existing data query, a query statement of a join type is usually used together with a plurality of data tables for query. The query statement of the join type usually includes a join key. If the query statement is specific to a data table that is not partitioned, or a data table is partitioned based on another data dimension different from the join key (for example, the join key is a user, but the data table is partitioned based on a region dimension), the join key needs to be used as a partition key to re-partition the data table. As such, this query is performed in each partition related to the join key, to ensure query performance. However, the above re-partitioning involves a shuffle of data. In other words, a storage location of a large amount of data in the data table is moved. This not only occupies a long period of time, but also causes great pressure on a disk, thereby severely affecting query performance.

The present specification provides a technical solution. A historical query record of a user can be actively collected, a query requirement of the user is analyzed, and a data table is effectively partitioned in advance based on this. As such, re-partitioning does not need to be performed in subsequent query, thereby greatly improving data query performance.

In implementations, in the present application, a plurality of historical query statements for a target data table can be obtained and parsed, to obtain at least one data dimension included in a query condition in the plurality of historical query statements. Further, in the present application, a target data dimension can be determined from the at least one data dimension, and partitioning processing is performed on the target data table based on the target data dimension, to divide the target data table into a plurality of data partitions. Then, in the present application, a to-be-executed target query statement can be obtained, and the target query statement is executed, to perform query processing in each of the plurality of data partitions obtained through division.

In the above technical solution, in the present application, the historical query statement for the target data table can be obtained, and the historical query statement is parsed, to obtain the at least one data dimension included in the historical query statement; and then the target data dimension is determined from the at least one data dimension. Further, in the present application, partitioning processing can be performed on the target data table based on the target data dimension, to divide the target data table into the plurality of data partitions, and some data in the target data table is stored in each data partition. Subsequently, after the to-be-executed target query statement is received in the present application, because the target data table is partitioned in advance based on a historical query requirement of a user in the present application, query processing can be directly performed in each of the plurality of data partitions obtained through division, and the data table does not need to be re-partitioned, thereby greatly improving data query performance.

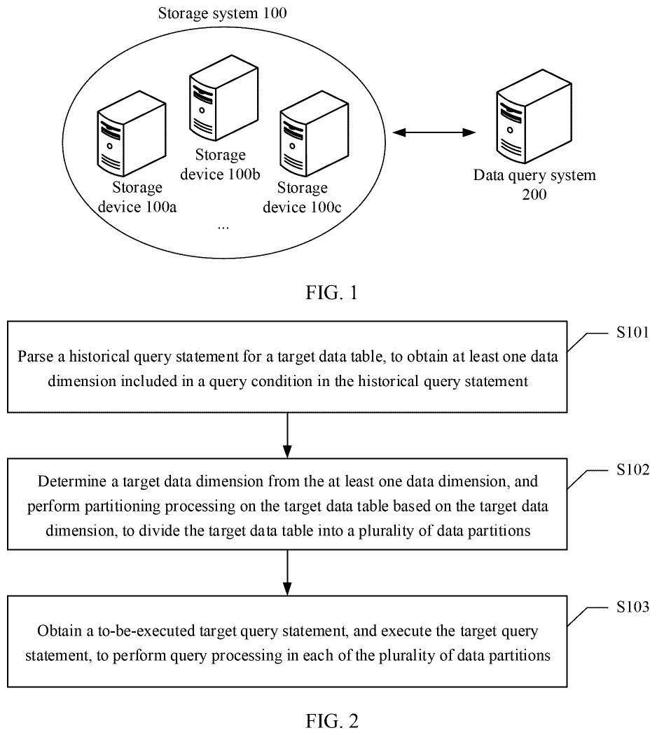

FIG. 1 is a schematic diagram of a system architecture according to an example implementation. One or more implementations provided in the present specification can be implemented in the system architecture shown in FIG. 1 or a similar system architecture. As shown in FIG. 1, the system can include a storage system 100 and a data query system 200. The storage system 100 can include a plurality of storage devices, for example, include a storage device 100a, a storage device 100b, and a storage device 100c. In an illustrative implementation, the data query system 200 can establish a communication connection with the storage system 100 in any possible manner. For example, the data query system 200 can establish a communication connection with the storage system 100 in a wireless network manner. This is not specifically limited in the present specification.

In an illustrative implementation, the storage system 100 can be a database system, and can include a plurality of data tables. The storage device 100a, the storage device 100b, the storage device 100c, etc. in the storage system 100 can be configured to store data in the plurality of data tables. Correspondingly, a user can perform a data query on the plurality of data tables by using the data query system 200. For example, the user can perform a query on one of the plurality of data tables, or can perform query by using an SQL statement of a join type in combination with the plurality of data tables. This is not specifically limited in the present specification.

In an illustrative implementation, the data query system 200 can obtain a historical query statement for a target data table, and perform parsing processing on the plurality of historical query statements, to obtain a data dimension included in a query condition in the historical query statement.

It should be noted that implementations of the present specification may use various type of historical query statements, which are all included in the scope of the specification. The scope of the specification is not limited by any specific type of the historical query statement. In an illustrative implementation, the historical query statement can be an SQL statement of a group by type, or can be an SQL statement of a join type, or can be an SQL statement of an aggregate (“agg”) type, etc. This is not specifically limited in the present specification.

For example, the historical query statement can be “select xxx group by user”. Herein, “user” is a data dimension, e.g., group by key, included in the query condition.

For example, the historical query statement can be “select xxx from a join b on a.user=b.user”. Herein, a and b can be two data tables on which this joint query is performed, and “user” is a data dimension, e.g., a join key, included in the query condition.

It should be noted that a manner of parsing the SQL statement to obtain the data dimension is not specifically limited in the present specification. In an illustrative implementation, in the present application, a Catalyst framework can be used to recursively traverse an SQL syntax tree, to obtain a key included in various SQL statements. For example, catalyst is a framework used to parse an SQL in a large-scale data calculation engine Spark. Details are omitted herein for simplicity. In an illustrative implementation, in the present application, the SQL statement can be parsed in any other possible manner, to obtain the data dimension included in the SQL statement.

For example, a complex nested query statement of an agg type is shown below. Herein, join is nested below agg, join further includes two sub-queries, and there is another agg in the 1^{st} sub-query. In the present application, a function tableName→alias can be first analyzed, and then a data column (e.g., a data dimension) that is in a data table and to which the query statement is, for example, found by using alias→column, etc. This is not specifically limited in the present specification.

* Agg
* --------Join
* ------------SubQueryAlias1
* --------------Agg
* ----------------Project
* -------------------Filter
* -----------------------Relation
*--------------SubQueryAlias2
*-------------------Project
*---------------------Filter
* -----------------------Relation

Based on a plurality of historical query statements of different query types (for example, the group by type, the join type, the agg type, and a distinct type), these data dimensions obtained through parsing can include a group by key, a join key, an agg key, a distinct key, etc. This is not specifically limited in the present specification.

Further, at least a part of at least one data dimension obtained by parsing the historical query statement can be used as a partition key for subsequent data partitioning.

Further, in an illustrative implementation, the data query system 200 can determine a target data dimension (e.g., a partition key) from the at least one obtained data dimension, and perform partitioning processing on the target data table based on the target data dimension, to divide the target data table into a plurality of data partitions. Each data partition obtained through division corresponds to one storage space, and some data in the target data table is stored in each data partition.

For example, before partitioning, all data in the target data table can be stored in the storage device 1000a. If the target data dimension is time, after data partitioning is performed on the target data table by time, the target data table can be divided into a plurality of data partitions, and the plurality of data partitions can respectively correspond to the storage device 100a, the storage device 100b, and the storage device 100c shown in FIG. 1. The storage device 100a can store a plurality of pieces of data whose date is 2023 in the target data table, the storage device 100b can store a plurality of pieces of data whose date is 2022 in the target data table, the storage device 100c can store a plurality of pieces of data whose date is 2021 in the target data table, etc. This is not specifically limited in the present specification.

For example, if the target data dimension is city, after data partitioning is performed on the target data table by city, the target data table can be divided into a plurality of data partitions, and the plurality of data partitions can respectively correspond to the storage device 100a, the storage device 100b, the storage device 100c, etc. shown in FIG. 1. The storage device 100a can store a plurality of pieces of data related to a city A in the target data table, the storage device 100b can store a plurality of pieces of data related to a city B in the target data table, the storage device 100c can store a plurality of pieces of data related to a city C in the target data table, etc. This is not specifically limited in the present specification.

In an illustrative implementation, the target data table can be an unpartitioned data table. Alternatively, the target data table can be a partitioned data table. As such, in the present application, partitioning of the target data table can be optimized based on the target data dimension obtained by parsing the historical query statement.

In an illustrative implementation, in the present application, while the target data table is constructed, partitioning processing can be performed on the target data table based on the target data dimension obtained by parsing the historical query statement. For example, the data query system 200 can construct the target data table by using a unified computing system (“UCS”, and perform partitioning processing on the target data table based on the target data dimension obtained by parsing the historical query statement. This is not specifically limited in the present specification.

Further, after completing partitioning processing on the target data table, the data query system 200 can obtain a to-be-executed target query statement for the target data table. A data dimension included in a query condition in the target query statement can be the target data dimension (for example, the above time or city). Correspondingly, by executing the target query statement, the data query system 200 can directly perform query processing in the plurality of data partitions obtained through partitioning, without a need to perform re-partitioning, thereby greatly improving data query efficiency.

In an illustrative implementation, data in the target data table can be raw data related to a merchant knowledge map. This is not specifically limited in the present specification.

In an illustrative implementation, the storage device 100a, the storage device 100b, the storage device 100c, etc. can be mutually independent storage devices, or can be different storage areas, for example, different files, in the same device. This is not specifically limited in the present specification.

In an illustrative implementation, the data query system 200 can be a system independent of the storage system 100, or the data query system 200 can be integrated into the storage system 100 as a functional module. This is not specifically limited in the present specification.

In an illustrative implementation, the data query system 200 can include an autonomous query engine (AQE). The AQE is an SQL optimization engine, and can optimize a subsequent query execution plan based on intermediate data in a query execution process, thereby improving overall query execution efficiency and improving data query performance.

As described herein, in the present application, while the data in the target data table is stored, data partitions are obtained through division, e.g., in advance, based on the target data dimension obtained by parsing the historical query statement of the user. Therefore, for the AQE, if the data dimension, for example, a join key, included in the to-be-executed target query statement is the same as the target data dimension of the data partition, re-partitioning does not need to be performed, e.g., a shuffle operator can be canceled, when the target query statement is executed, and query processing is directly performed based on the plurality of data partitions obtained through division, thereby greatly reducing a calculation amount and improving query performance.

FIG. 2 is a schematic flowchart of a data query method according to an example implementation. The method can be applied to the system architecture shown in FIG. 1, and can be applied to the data query system 200 in the system architecture shown in FIG. 1. As shown in FIG. 2, the method can include step S101 to step S103.

Step S101: Parse a historical query statement for a target data table, to obtain at least one data dimension included in a query condition in the historical query statement.

In an illustrative implementation, in the present application, one or more historical query statements for the target data table can be obtained. For example, in the present application, all historical query statements of a user for the target data table can be collected through an entry of all queries.

It should be noted that the scope of the present specification is not limited by any specific type of the historical query statement. In an illustrative implementation, the historical query statement can be an SQL statement of a join type, or can be an SQL statement of an agg type, or can be an SQL statement of a group by type, or can be an SQL statement of a distinct type, etc. This is not specifically limited in the present specification. For details, refer to the descriptions in the implementations corresponding to FIG. 1.

Further, in the present application, parsing processing can be performed on the obtained historical query statement, to obtain the at least one data dimension included in the query condition in the historical query statement.

In an illustrative implementation, in the present application, a Catalyst framework can be used to recursively traverse an SQL syntax tree, to obtain the data dimension included in the historical query statement. In some possible implementations, in the present application, the data dimension included in the historical query statement can alternatively or additionally be obtained in any other possible method. This is not specifically limited in the present specification.

For example, based on a plurality of historical query statements of different query types, for example, the group by type, the join type, the agg type, or the distinct type, these data dimensions obtained through parsing can include a group by key, a join key, an agg key, a distinct key, etc. This is not specifically limited in the present specification.

In addition, in the present application, different parsing methods can be respectively used for different types of historical query statements, to obtain data dimensions included in the different types of historical query statements. This is not specifically limited in the present specification.

In an illustrative implementation, in the present application, the historical query statement of the user for the target data table can be obtained and parsed by using an adaptive query execution “AQE”.

Further, to improve parsing efficiency for the historical query statement, and more quickly and effectively obtain the data dimension included in the historical query statement, the AQE can preprocess a large number of obtained historical query statements, to select historical query statements with the same pattern from the large number of historical query statements, and then perform parsing processing on these selected historical query statements, to obtain a data dimension included in the historical query statements.

For example, if only time conditions for a where clause in different historical query statements are different, the different historical query statements cannot be considered to have the same pattern. After obtaining the large number of historical query statements, the AQE needs to filter out impact of an unrelated expression, to ensure subsequent statement parsing efficiency.

Step S102: Determine a target data dimension from the at least one data dimension, and perform partitioning processing on the target data table based on the target data dimension, to divide the target data table into a plurality of data partitions.

Further, in the present application, partition information of the target data table can be further obtained based on the at least one data dimension obtained through parsing. In an illustrative implementation, the partition information can include a partition key of the data partition and a number of partitions (partition size).

It can be understood that the at least one data dimension obtained by parsing the historical query statement is not necessarily suitable for use as the partition key of the data partition. Therefore, in an illustrative implementation, in the present application, the target data dimension (e.g., the partition key) can be determined from the at least one data dimension obtained through parsing.

In an illustrative implementation, there can be one or more target data dimensions. This is not specifically limited in the present specification. In other words, in the present application, partitioning processing can be performed on the target data table based on a combination of one or more partition keys.

It should be noted that the scope of the present specification is not limited by any specific method for determining the target data dimension from the at least one data dimension.

In an illustrative implementation, if a data column corresponding to a data dimension in the target data table is a high-cardinality column, the data dimension can be determined as the target data dimension. It should be noted that a repetition rate of data included in the high-cardinality column is usually small.

For example, in the present application, whether a repetition rate of data in a data column corresponding to a data dimension of the at least one data dimension in the target data table is less than a first determined value can be first determined. Further, the data dimension can be determined as the target data dimension if the repetition rate of the data in the data column corresponding to the data dimension is less than the first determined value.

In an illustrative implementation, the first determined value can be set based on an actual situation. For example, the first determined value can be 20%, 15%, or 10%. This is not specifically limited in the present specification.

For example, a user dimension is used as an example. The target data table includes a total of 100 rows of data, and the 100 rows of data all are data of different users. In other words, if a repetition rate of data in a data column corresponding to the user dimension is 0, the user dimension can be determined as the target data dimension.

For example, a city dimension is used as an example. The target data table includes a total of 100 rows of data, and 80 of the 100 rows of data all are data of a city A. In other words, if a repetition rate of data in a data column corresponding to the city dimension is up to 80%, the city dimension is not suitable to be used as a partition key. It should be understood that if the target data table is partitioned based on the city dimension, a large amount of data of the city A still needs to be stored in one data partition, and the data is not evenly allocated to a plurality of data partitions. Consequently, subsequent data query efficiency cannot be improved.

Further, after the target data dimension is determined, a number of data partitions and a data range corresponding to each data partition can be further determined in the present application.

In an illustrative implementation, in the present application, a proper number of data partitions and a data range corresponding to each data partition can be determined based on a data amount (or a number of rows) in the data column corresponding to the target data dimension in the target data table.

Further, based on the number of data partitions and the data range corresponding to each data partition that are determined, in the present application, partitioning processing can be performed on the target data table, to divide the target data table into the number of data partitions. Correspondingly, data in the corresponding data range in the target data table can be stored in each of the number of data partitions.

It should be noted that, a larger number of partitions does not necessarily indicate a better a case. If a data amount is small but a number of partitions is too large, during a subsequent data query, too many tasks are started, and each task is very fragmented, which increases pressure on a driver, and severely affects data query performance.

In an illustrative implementation, the number of data partitions can be in direct proportion to the data amount in the data column corresponding to the target data dimension. For example, a larger data amount causes a larger number of data partitions. As such, a data query burden in each data partition can be reduced.

For example, the target data dimension is a user dimension. A data column corresponding to the user dimension may include tens of thousands of rows of data. If each user corresponds to one data partition, tens of thousands of data partitions are generated, which affects subsequent data query performance. If only two data partitions are obtained through division, each data partition includes data of tens of thousands of users, which also affects subsequent data query performance. Therefore, in the present application, a proper number of partitions needs to be determined, to classify data of several users into the same data partition. For example, if the target data table includes data related to ten thousand users, it can be determined that the number of data partitions is 100, and data related to a hundred users is stored in each data partition. This is not specifically limited in the present specification.

In addition, in an illustrative implementation, in the present application, sorting information can be further obtained by parsing the historical query statement. For example, the partition information can further include the sorting information. Data in each data partition obtained through division can be orderly stored based on the sorting information. For example, the target data dimension is user. The data in each data partition can be stored in an alphabetical order of user names. For example, the target data dimension is time. The data in each data partition can be stored in a date sequence, etc. This is not specifically limited in the present specification.

It should be noted that a specific type of the partition is not specifically limited in the present specification. In an illustrative implementation, a type of the partition is mainly any one of the following: a range partition, a hash partition, a predefined list partition, a key partition, etc. This is not specifically limited in the present specification.

For example, the data partition is a hash partition. The data range corresponding to each data partition can include a hash value corresponding to each hash partition.

In an illustrative implementation, in the present application, when partitioning processing is performed on the target data table based on the number of data partitions and the data range corresponding to each data partition that are determined, details can specifically include: dividing the target data table into the number of hash partitions based on the determined number of hash partitions; and determining a dimension value (e.g., a value corresponding to a key) that corresponds to the target data dimension and that is included in each piece of data in the target data table, calculating a hash value corresponding to the dimension value, and storing each piece of data in a hash partition corresponding to the calculated hash value.

For example, a dimension value corresponding to the user dimension can include user names such as Jim, Tom, and Jerry. For example, a dimension value corresponding to the city dimension can include the city A, a city B, and a city C. If hash values calculated for the city A and the city B can be the same, data related to the city A and the city B can be classified into the same data partition.

It should be noted that a specific algorithm used for calculating the hash value is not specifically limited in the present specification. In an illustrative implementation, an MD5 value corresponding to each dimension value can be calculated based on a message-digest algorithm 5 (MD5). In some possible implementations, the hash value corresponding to each dimension value can alternatively be calculated based on a secure hash algorithm (SHA), a data encryption standard (DES) algorithm, an advanced encryption standard (AES) algorithm, etc. This is not specifically limited in the present specification.

In an illustrative implementation, in the present application, the historical query statement for the target data table in each duration period can be periodically obtained and parsed based on a determined duration period, to periodically obtain the partition information of the target data table. As such, partitioning of the target data table is continuously optimized based on a latest query requirement of the user, thereby ensuring long-term query performance.

It can be understood that if partition information obtained in a current period is consistent with partition information in a previous period, and partitioning processing is performed on the target data table based on the partition information obtained in the previous period, partitioning processing may not be performed on the target data table this time, to save computing resources and temporary storage resources.

It should be noted that a specific manner of comparing partition information obtained in two adjacent periods is not particularly limited in the present specification.

In an illustrative implementation, in the present application, whether the partition information obtained in the previous period and the partition information obtained in the current period include the same partition key, number of partitions, and sorting information, etc., if all items of information are one-to-one correspondingly the same, it indicates that the partition information obtained in the previous period is the same as the partition information obtained in the current period.

In an illustrative implementation, in the present application, MD5 values of the partition information obtained in the two adjacent periods can be first calculated. If the MD5 values of the partition information obtained in the two adjacent periods are the same, it indicates that the partition information obtained in the previous period is the same as the partition information obtained in the current period.

In an illustrative implementation, in the present application, the historical query statement may not be parsed based on a fixed duration period to obtain the partition information. Instead, each time the determined number of historical query statements are collected, parsing can be performed to obtain the partition information, etc. This is not specifically limited in the present specification.

In an illustrative implementation, early-stage collection and parsing of the historical query statement and subsequent partitioning processing need to occupy some computing resources and some temporary storage resources. Therefore, if a data amount in the target data table is small, the data partition usually cannot bring an ideal benefit. Therefore, when the data amount in the target data table is small, in the present application, the historical query statement may alternatively not be collected or parsed for partitioning processing.

For example, in the present application, whether the data amount in the target data table is greater than a second determined value can be first determined. If yes, the historical query statement for the target data table is obtained and parsed, to obtain corresponding partition information and perform partitioning processing on the target data table, etc. It should be noted that a specific value of the second determined value is not specifically limited in the present specification, and can be set based on an actual situation or requirement.

In addition, it should be noted that the data partition involved in the present application is an optimization item for the target data table. To not interfere with a running status of an online task, in the present application, partitioning processing can be performed on the target data table when a cluster is idle. Further, in an illustrative implementation, the optimization item, e.g., the data partition can be a program application that detects a cluster idle rate and that is started in the background.

In addition, in some possible implementations, in the present application, in addition to the historical query statement for the target data table, the partition information of the target data table can be obtained by obtaining and parsing a historical query statement for another data table, etc. This is not specifically limited in the present specification. There can be a data association between the another data table and the target data table.

Step S103: Obtain a to-be-executed target query statement, and execute the target query statement, to perform query processing in each of the plurality of data partitions.

In an illustrative implementation, the to-be-executed target query statement can be obtained after partitioning processing on the target data table is completed. A data dimension included in a query condition in the target query statement can be the target data dimension. Because partitioning processing is performed on the target data table in advance in the present application, in the present application, when the target query statement is executed, query processing can be performed in each of the plurality of data partitions obtained through division, and a query result is obtained. Details are omitted herein for simplicity.

Further, in the present application, the query result of the target query statement can be output to the user, etc.

In conclusion, in the present application, the historical query statement for the target data table can be obtained, and the historical query statement is parsed, to obtain the at least one data dimension included in the historical query statement; and then the target data dimension is determined from the at least one data dimension. Further, in the present application, partitioning processing can be performed on the target data table based on the target data dimension, to divide the target data table into the plurality of data partitions, and some data in the target data table is stored in each data partition. Subsequently, after the to-be-executed target query statement is received in the present application, because the target data table is partitioned in advance based on a historical query requirement of a user in the present application, query processing can be directly performed in each of the plurality of data partitions obtained through division, and the data table does not need to be re-partitioned, thereby greatly improving data query performance.

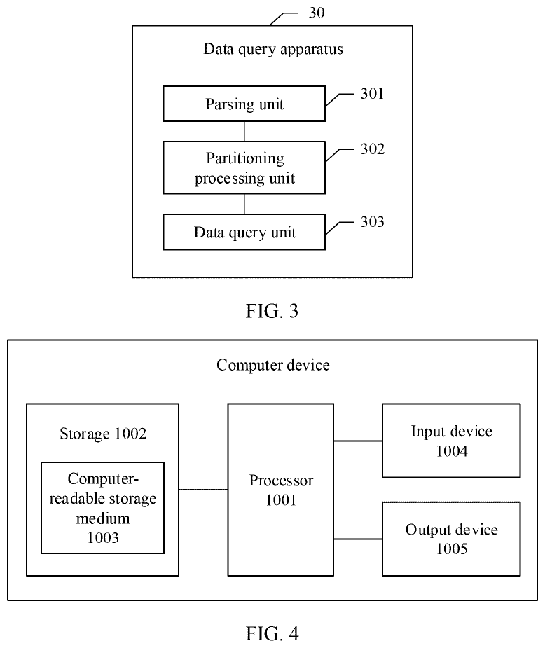

Corresponding to the above method procedure implementation, an implementation of the present specification further provides a data query apparatus. FIG. 3 is a schematic structural diagram of a data query apparatus 30 according to an example implementation. The apparatus 30 can be applied to the data query system 200 in the system architecture shown in FIG. 1. As shown in FIG. 3, the apparatus 30 includes: a parsing unit 301, configured to parse a historical query statement for a target data table, to obtain at least one data dimension included in a query condition in the historical query statement; a partitioning processing unit 302, configured to: determine a target data dimension from the at least one data dimension, and perform partitioning processing on the target data table based on the target data dimension, to divide the target data table into a plurality of data partitions; and a data query unit 303, configured to: obtain a to-be-executed target query statement, and execute the target query statement, to perform query processing in each of the plurality of data partitions.

In an illustrative implementation, the partitioning processing unit 302 is configured to: determine whether a repetition rate of data in a data column corresponding to a data dimension of the at least one data dimension in the target data table is less than a first determined value; and determine the data dimension as the target data dimension if the repetition rate of the data in the data column corresponding to the data dimension is less than the first determined value.

In an illustrative implementation, the partitioning processing unit 302 is configured to: determine a number of data partitions and a data range corresponding to each data partition based on a data amount in the data column corresponding to the target data dimension in the target data table; and perform partitioning processing on the target data table based on the number of data partitions and the data range corresponding to each data partition that are determined, to divide the target data table into the plurality of data partitions whose number is the determined number. Each of the number of data partitions stores data in the corresponding data range in the target data table.

In an illustrative implementation, each data partition is a hash partition, and the data range corresponding to each data partition includes a hash value corresponding to the hash partition; and the partitioning processing unit 302 is configured to: divide the target data table into the number of hash partitions based on the determined number of hash partitions; and determine a dimension value that corresponds to the target data dimension and that is included in each piece of data in the target data table, calculate a hash value corresponding to the dimension value, and store each piece of data in a hash partition corresponding to the calculated hash value.

In an illustrative implementation, the parsing unit 301 is configured to: periodically obtain the historical query statement for the target data table in each duration period based on a determined duration period, and parse the historical query statement.

In an illustrative implementation, that the parsing unit 301 is configured to parse the historical query statement for the target data table includes: determining whether a data amount in the target data table is greater than a second determined value; and if yes, parsing the historical query statement for the target data table, to perform partitioning processing on the target data table.

In an illustrative implementation, the historical query statement and the target query statement are a query statement of a join type or a query statement of an agg type.

For an example implementation process of functions and roles of units in the apparatus 30, references can be made to descriptions of the implementations corresponding to FIG. 1 and FIG. 2. Details are omitted herein for simplicity. It should be understood that the apparatus 30 can be implemented by using software, or can be implemented by using hardware or a combination of software and hardware. Software implementation is used as an example. A logical apparatus is implemented by reading, by using a processor (CPU) of a device in which the apparatus is located, corresponding computer program instructions into a memory for running. In terms of hardware, in addition to the CPU and the storage, the device in which the apparatus is located usually further includes other hardware such as a chip used to send and receive a wireless signal, and/or other hardware such as a board used to implement a network communication function.

The apparatus implementation described above is merely an example. The units described as separate parts may or may not be physically separate, and parts displayed as units may or may not be physical modules, that is, can be located in one place, or can be distributed on a plurality of network modules. Some or all of the units or modules can be selected based on actual needs to achieve the objectives of the solutions in the present specification. A person of ordinary skill in the art can understand and implement the solutions of the present application without creative efforts.

Apparatuses, units, and modules that are set forth in the previous implementations can be embodied by a computer chip or an entity or by a product with a specific function. An example implementation device is a computer. An example form of the computer can be a personal computer, a laptop computer, a cellular phone, a camera phone, a smartphone, a personal digital assistant, a media player, a navigation device, an email transceiver device, a game console, a tablet computer, a wearable device, a vehicle-mounted computer, or any combination of several of these devices.

Corresponding to the above method implementations, an implementation of the present specification further provide a computer device. FIG. 4 is a schematic structural diagram of a computer device according to an example implementation. The computer device shown in FIG. 4 can be a computer device in the data query system 200 in the system architecture shown in FIG. 1. As shown in FIG. 4, the computer device includes a processor 1001 and a storage 1002, and can further include an input device 1004 (for example, a keyboard) and an output device 1005 (for example, a display). The processor 1001, the storage 1002, the input device 1004, and the output device 1005 can be connected through a bus or in another manner. As shown in FIG. 4, the storage 1002 includes a computer-readable storage medium 1003, and the computer-readable storage medium 1003 stores a computer program that can be run by the processor 1001. The processor 1001 can be a CPU, a microprocessor, or an integrated circuit configured to control execution of the above method implementations. When running the stored computer program, the processor 1001 can perform steps of the data query method in the implementations of the present specification, including: parsing a historical query statement for a target data table, to obtain at least one data dimension included in a query condition in the historical query statement; determining a target data dimension from the at least one data dimension, and performing partitioning processing on the target data table based on the target data dimension, to divide the target data table into a plurality of data partitions; and obtaining a to-be-executed target query statement, and executing the target query statement, to perform query processing in each of the plurality of data partitions; etc.

For detailed description of the steps of the data query method, references can be made to the above content. Details are omitted herein for simplicity.

Corresponding to the above method implementation, an implementation of the present specification further provides a computer-readable storage medium. The storage medium stores a computer program, and when the computer program is run by a processor, steps of the data query method in the implementations of the present specification are performed. For details, references can be made to the above descriptions of the implementations corresponding to FIG. 1 and FIG. 2. Details are omitted herein for simplicity.

The above descriptions are merely example implementations of the present specification, but are not intended to limit the present specification. Any modification, equivalent replacement, or improvement made without departing from the spirit and principle of the present specification shall fall within the protection scope of the present specification.

In an example configuration, a terminal device includes one or more CPUs, an input/output interface, a network interface, and a memory.

The memory may include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

In an example configuration, the terminal device includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The computer-readable medium includes persistent, non-persistent, removable, and non-removable media that can store information by using any method or technology. The information can be computer-readable instructions, a data structure, a program module, or other data.

Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device or any other non-transmission media that can be configured to store information that a computing device can access. As described in the present specification, the computer-readable medium does not include transitory computer-readable media (transitory media) such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

A person skilled in the art should understand that the implementations of the present specification can be provided as a method, a system, or a computer program product. Therefore, the implementations of the present specification can be in a form of hardware only implementations, software only implementations, or implementations with a combination of software and hardware. Moreover, the implementations of the present specification can be in a form of a computer program product that is implemented on one or more computer-usable storage media (including but not limited to a disk memory, a CD-ROM, an optical memory, etc.) that include computer-usable program code.

What is claimed is:

1. A data query method, comprising:
parsing a historical query statement for a target data table, to obtain at least one data dimension included in a query condition in the historical query statement;
determining a target data dimension from the at least one data dimension;
partitioning the target data table based on the target data dimension, to divide the target data table into a plurality of data partitions; and
perform query processing in each of the plurality of data partitions based on a target query statement.

2. The method according to claim 1, wherein the determining the target data dimension from the at least one data dimension includes:
determining whether a repetition rate of data in a data column corresponding to a data dimension of the at least one data dimension in the target data table is less than a first value; and
determining the data dimension as the target data dimension in response to that the repetition rate of the data in the data column corresponding to the data dimension is less than the first value.

3. The method according to claim 1, wherein the partitioning the target data table based on the target data dimension includes:
determining a number of data partitions and a data range corresponding to each data partition based on a data amount in the data column corresponding to the target data dimension in the target data table; and
partitioning the target data table based on the number of data partitions and the data range corresponding to each data partition, to divide the target data table into the number of data partitions, wherein each of the number of data partitions stores data in the data range corresponding to the data partition in the target data table.

4. The method according to claim 3, wherein each data partition is a hash partition, and the data range corresponding to each data partition includes a hash value corresponding to the hash partition; and
the partitioning the target data table based on the number of data partitions and the data range corresponding to each data partition includes:
dividing the target data table into the number of hash partitions based on the determined number of hash partitions;
determining a dimension value that corresponds to the target data dimension and that is included in each piece of data in the target data table;
calculating a hash value corresponding to the dimension value; and
storing each piece of data in a hash partition corresponding to the hash value calculated.

5. The method according to claim 1, wherein the parsing the historical query statement for the target data table includes:
periodically obtaining a historical query statement for the target data table in each duration period, and parsing the historical query statement obtained.

6. The method according to claim 1, wherein the parsing the historical query statement for the target data table includes:
determining whether a data amount in the target data table is greater than a second value; and
in response to that the data amount in the target data table is greater than the second value, parsing the historical query statement for the target data table.

7. The method according to claim 1, wherein the historical query statement and the target query statement are each a query statement of a join type or a query statement of an aggregate type.

8. A computer system, comprising one or more storage devices and one or more processors, the one or more storage device, individually or collectively, having computer executable instructions stored thereon, the computer executable instructions, when executable by the one or more processors, enabling the one or more processors to, individually or collectively implement acts including:
parsing a historical query statement for a target data table, to obtain at least one data dimension included in a query condition in the historical query statement;
determining a target data dimension from the at least one data dimension;
partitioning the target data table based on the target data dimension, to divide the target data table into a plurality of data partitions; and
perform query processing in each of the plurality of data partitions based on a target query statement.

9. The computer system according to claim 8, wherein the determining the target data dimension from the at least one data dimension includes:
determining whether a repetition rate of data in a data column corresponding to a data dimension of the at least one data dimension in the target data table is less than a first value; and
determining the data dimension as the target data dimension in response to that the repetition rate of the data in the data column corresponding to the data dimension is less than the first value.

10. The computer system according to claim 8, wherein the partitioning the target data table based on the target data dimension includes:
determining a number of data partitions and a data range corresponding to each data partition based on a data amount in the data column corresponding to the target data dimension in the target data table; and
partitioning the target data table based on the number of data partitions and the data range corresponding to each data partition, to divide the target data table into the number of data partitions, wherein each of the number of data partitions stores data in the data range corresponding to the data partition in the target data table.

11. The computer system according to claim 10, wherein each data partition is a hash partition, and the data range corresponding to each data partition includes a hash value corresponding to the hash partition; and
the partitioning the target data table based on the number of data partitions and the data range corresponding to each data partition includes:
dividing the target data table into the number of hash partitions based on the determined number of hash partitions;
determining a dimension value that corresponds to the target data dimension and that is included in each piece of data in the target data table;
calculating a hash value corresponding to the dimension value; and
storing each piece of data in a hash partition corresponding to the hash value calculated.

12. The computer system according to claim 8, wherein the parsing the historical query statement for the target data table includes:
periodically obtaining a historical query statement for the target data table in each duration period, and parsing the historical query statement obtained.

13. The computer system according to claim 8, wherein the parsing the historical query statement for the target data table includes:
determining whether a data amount in the target data table is greater than a second value; and
in response to that the data amount in the target data table is greater than the second value, parsing the historical query statement for the target data table.

14. The computer system according to claim 8, wherein the historical query statement and the target query statement are each a query statement of a join type or a query statement of an aggregate type.

15. A computer-readable storage medium having computer executable instructions stored thereon, the computer executable instructions, when executable by one or more processors, enabling the one or more processors to, individually or collectively implement acts including:
parsing a historical query statement for a target data table, to obtain at least one data dimension included in a query condition in the historical query statement;
determining a target data dimension from the at least one data dimension;
partitioning the target data table based on the target data dimension, to divide the target data table into a plurality of data partitions; and
perform query processing in each of the plurality of data partitions based on a target query statement.

16. The computer-readable storage medium according to claim 15, wherein the determining the target data dimension from the at least one data dimension includes:
determining whether a repetition rate of data in a data column corresponding to a data dimension of the at least one data dimension in the target data table is less than a first value; and
determining the data dimension as the target data dimension in response to that the repetition rate of the data in the data column corresponding to the data dimension is less than the first value.

17. The computer-readable storage medium according to claim 15, wherein the partitioning the target data table based on the target data dimension includes:
determining a number of data partitions and a data range corresponding to each data partition based on a data amount in the data column corresponding to the target data dimension in the target data table; and
partitioning the target data table based on the number of data partitions and the data range corresponding to each data partition, to divide the target data table into the number of data partitions, wherein each of the number of data partitions stores data in the data range corresponding to the data partition in the target data table.

18. The computer-readable storage medium according to claim 17, wherein each data partition is a hash partition, and the data range corresponding to each data partition includes a hash value corresponding to the hash partition; and
the partitioning the target data table based on the number of data partitions and the data range corresponding to each data partition includes:
dividing the target data table into the number of hash partitions based on the determined number of hash partitions;
determining a dimension value that corresponds to the target data dimension and that is included in each piece of data in the target data table;
calculating a hash value corresponding to the dimension value; and
storing each piece of data in a hash partition corresponding to the hash value calculated.

19. The computer-readable storage medium according to claim 15, wherein the parsing the historical query statement for the target data table includes:
determining whether a data amount in the target data table is greater than a second value; and
in response to that the data amount in the target data table is greater than the second value, parsing the historical query statement for the target data table.

20. The computer-readable storage medium according to claim 15, wherein the historical query statement and the target query statement are each a query statement of a join type or a query statement of an aggregate type.
